(19) United States
(12) Patent Application Publication
(10) Pub. No.: US 2007/0019601 A1
(43) Pub. Date: Jan. 25, 2007

(54) Method and apparatus for controlling a function of a mobile phone in a mobile communication system

(75) Inventors: Sung-Sick Kim, Suwon-si (KR); Geun-Myeon Lee, Suwon-si (KR); Keun-Soo Kim, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignees: Samsung Electronics Co., Ltd.; Seoul Commtech Ltd.

(21) Appl. No.: 11/480,509

(22) Filed: Jul. 5, 2006

(30) Foreign Application Priority Data
Jul. 4, 2005 (KR) 10-2005-0059933

(51) Int. Cl. H04B 7/216

(52) U.S. Cl. 370/342

(57) ABSTRACT

An apparatus and method are provided for controlling a function of a mobile phone in a mobile communication system. The method includes the steps of receiving a pilot signal with a Pseudo Noise (PN) code; determining whether the received pilot signal has a predefined PN offset, setting a restriction of a particular function of the user terminal when the pilot signal is a predefined first PN offset; and releasing the restriction of the particular function of the user terminal when the pilot signal is a predefined second PN offset.

### CROSS-REFERENCE TO RELATED APPLICATIONS

This application claims the benefit under 35 U.S.C. §119(a) of Korean Patent Application No. 10-2005-0059933, entitled “Method and Apparatus for Controlling a Function of a Mobile Phone in a Mobile Communication System” filed in the Korean Intellectual Property Office on Jul. 4, 2005, the entire disclosure of which is incorporated herein by reference.

### BACKGROUND OF THE INVENTION

1. Field of the Invention

The present invention generally relates to a mobile communication system. More particularly, the present invention relates to a method and apparatus for efficiently controlling various functions of a mobile phone in a specific area.

2. Description of the Related Art

Today, with the development of communication technologies, mobile phones have become a necessity for almost every person. However, as these mobile phones have various functions and high performance, problems such as privacy infringement, information leakage, and so on, may occur. Also, even in areas where the use of mobile phones is restricted, many people still make phone calls or use ringtones.

For example, a picture of a person or confidential document can be taken using a camera phone without permission and picture data then stored in a memory of the mobile phone. We can easily see persons who make phone calls or use ringtones in concert halls or theaters. In a specific area or building where security is required, mobile phones of persons who enter are often temporarily secured, such as being kept in a depository, or camera lenses of all mobile phones with camera modules are covered. Further, requests can be made such that mobile phones should be disabled in concert halls or theaters before actual performances. However, many persons do not follow these requests.

Thus, research has been conducted on systems for automatically controlling a function of a mobile phone within a specific area.

FIG. 1 is a block diagram of a structure of a conventional transmitter for transmitting a signal for controlling a mobile phone.

In FIG. 1, the conventional transmitter for transmitting a signal for controlling the mobile phone generates a control signal of a predefined particular format through a control signal generator 105 and modulates the generated control signal through a modulator 115. The modulated signal is carried on a high frequency signal generated from an oscillator 110 and is amplified by an amplifier 120. The amplified signal is transmitted to a receiver through a matching circuit 125.

As described above, the conventional transmitter for transmitting a signal for controlling the mobile phone generates the control signal using a signal of a particular frequency band rather than a frequency and signal used for the conventional mobile phone, or uses a particular signal generator, an infrared communication scheme, and so forth. To receive the control signal in the mobile phone, a special receiver mapped to the transmitter should be provided. To process the control signal, various devices are required.

FIG. 2 is a block diagram of a structure of a conventional receiver for receiving a signal for controlling the mobile phone.

In FIG. 2, the conventional receiver for receiving a signal for controlling the mobile phone receives a radio signal including a control signal from the transmitter for transmitting a signal for controlling the mobile phone as illustrated in FIG. 1. The receiver extracts a signal of a desired frequency band through a separator 205. The extracted signal is amplified in a low power amplifier 210. The amplified signal is transferred to an Intermediate Frequency (IF) converter 220. The IF converter 220 mixes the amplified signal with a frequency signal input from an oscillator 215 and generates an IF signal. A demodulator 230 demodulates the IF signal and outputs the control signal. In response to the control signal, a particular function of the mobile phone is controlled.

Because a special receiver is required in a mobile phone for a conventional operation for controlling a function of the mobile phone, the price of the mobile phone increases and mobile phones already produced without the special receiver cannot be controlled. Because a function application in a newly produced mobile phone is set according to a manufacturing company, it is generally not used. Furthermore, there is a problem in that a function of the mobile phone cannot be controlled beyond an area where a control signal can be received.

Accordingly, a need exists for a system and method for effectively and efficiently controlling various functions of a mobile phone.

### SUMMARY OF THE INVENTION

Accordingly, the present invention has been designed to substantially solve the above and other problems occurring in the prior art. Therefore, it is an object of embodiments of the present invention to provide a method and apparatus that can control a function of a mobile phone by employing an existing frequency rather than a special frequency, and changing only the software of the mobile phone to do so.

It is another object of embodiments of the present invention to provide a method and apparatus that can control various functions of a mobile phone using a pilot signal.

It is yet another object of embodiments of the present invention to provide a method and apparatus that can easily configure a network and efficiently control a function of a mobile phone in a system for controlling the function of the mobile phone using a pilot signal.

In accordance with an aspect of embodiments of the present invention, there is provided a method for controlling a function of a user terminal in a mobile communication system, comprising the steps of: receiving a pilot signal with a Pseudo Noise (PN) code; determining whether the received pilot signal has a predefined PN offset; setting a restriction of a particular function of the user terminal when the pilot signal is a predefined first PN offset; and releasing the restriction of the particular function of the user terminal when the pilot signal is a predefined second PN offset.

In accordance with another aspect of embodiments of the present invention, there is provided an operation method in a transmitter for transmitting a signal for controlling a user terminal in a mobile communication system, the transmitter having transmission areas serving as a first area where a restriction of a particular function of the user terminal is set and a second area where the set function restriction is released, respectively, comprising the steps of: generating pilot signals having a Pseudo Noise (PN) offset defined to set the restriction of the particular function of the user terminal and a PN offset defined to release the set restriction of the particular function, respectively; and transmitting the generated pilot signals to the first and second areas.

In accordance with another aspect of embodiments of the present invention, there is provided a method for controlling a function of a user terminal in a mobile communication system, comprising the steps of: having transmission areas serving as a first area where a restriction of a particular function of the user terminal is set and a second area where the set function restriction is released and transmitting a first pilot signal defined to restrict the particular function of the user terminal and a second pilot signal defined to release the restriction of the particular function to the first and second areas; setting the restriction of the particular function when the user terminal receives the first pilot signal; and releasing the restriction of the particular function set in the user terminal when the second pilot signal is received.

In accordance with another aspect of embodiments of the present invention, there is provided an apparatus for controlling a function of a user terminal in a mobile communication system, comprising: a receiver for receiving a pilot signal with a Pseudo Noise (PN) code; a determiner for determining whether the received pilot signal has a predefined PN offset; and a controller for setting a restriction of a particular function of the user terminal when the pilot signal is a predefined first PN offset and releasing the restriction of the particular function set in the user terminal when the pilot signal is a predefined second PN offset.

In accordance with another aspect of embodiments of the present invention, there is provided an apparatus for transmitting a signal for controlling a user terminal in a mobile communication system having transmission areas serving as a first area where a restriction of a particular function of the user terminal is set and a second area where the set function restriction is released, respectively, comprising: a control signal generator for generating pilot signals having a Pseudo Noise (PN) offset defined to set the restriction of the particular function of the user terminal and a PN offset defined to release the set restriction of the particular function, respectively; and a transmitter for transmitting the generated pilot signals to the first and second areas.

In accordance with yet another aspect of embodiments of the present invention, there is provided a mobile communication system for controlling a function of a user terminal, comprising: a control signal transmitter for having transmission areas serving as a first area where a restriction of a particular function of the user terminal is set and a second area where the set function restriction is released and transmitting a first pilot signal defined to restrict the particular function of the user terminal and a second pilot signal defined to release the restriction of the particular function to the first and second areas; and the user terminal for setting the restriction of the particular function when receiving first pilot signal and releasing the set restriction of the particular function when receiving the second pilot signal.

### BRIEF DESCRIPTION OF THE DRAWINGS

The above and other objects and aspects of embodiments of the present invention will become more clearly understood from the following detailed description taken in conjunction with the accompanying drawings, in which:

FIG. 1 is a block diagram of a structure of a conventional transmitter for transmitting a signal for controlling a mobile phone;

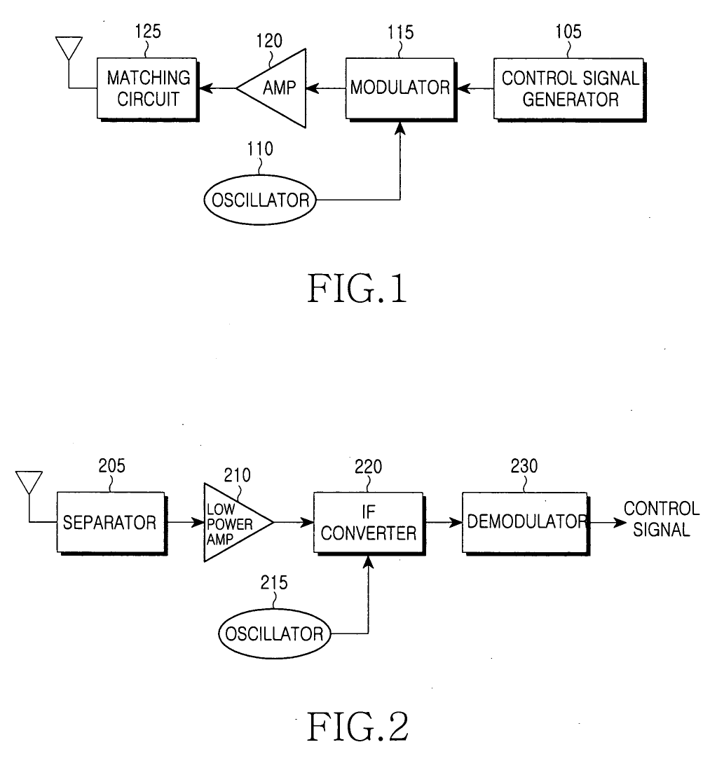

FIG. 2 is a block diagram of a structure of a conventional receiver for receiving a signal for controlling a mobile phone;

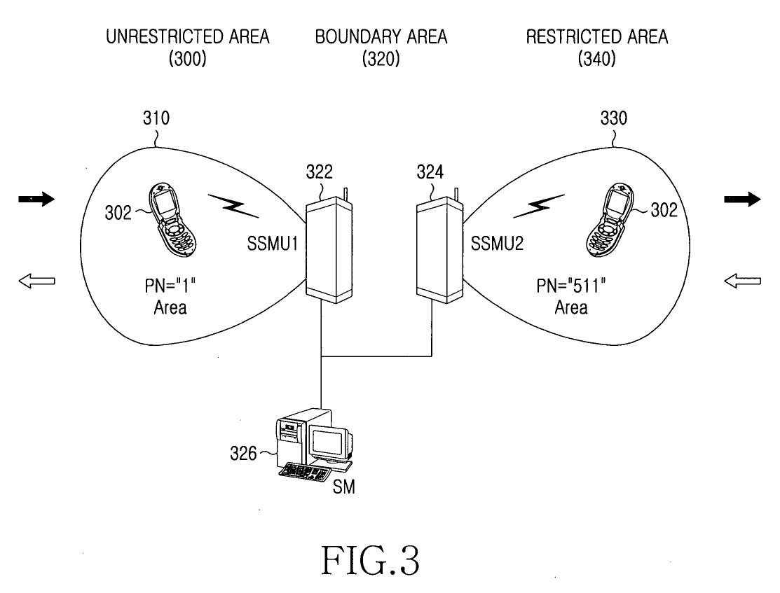

FIG. 3 illustrates a structure of a system for controlling a function of a mobile phone in accordance with an exemplary embodiment of the present invention;

FIG. 4 is a block diagram of a transmitter for transmitting a signal for controlling a mobile phone in accordance with an exemplary embodiment of the present invention;

FIGS. 5 and 6 are flowcharts illustrating an operation for controlling a function of a mobile phone in accordance with an exemplary embodiment of the present invention; and

FIG. 7 is a block diagram of a structure for controlling a function of a mobile phone in accordance with an exemplary embodiment of the present invention.

Throughout the drawings, like reference numerals will be understood to refer to like parts, components and structures.

### DETAILED DESCRIPTION OF THE EXEMPLARY EMBODIMENTS

Operation principles of exemplary embodiments of the present invention will now be described in detail herein below with reference to the accompanying drawings. In the following description, detailed descriptions of functions and configurations incorporated herein that are well known to those skilled in the art are omitted for clarity and conciseness. It is to be understood that the phraseology and terminology employed herein are for the purpose of description and should not be regarded as limiting the present invention.

In the following description, controlling mobile phone's functions will be described. However, it is noted that all devices i.e. PDA or laptop computer which can communicate with by transmitting/receiving a pilot signal having a PN offset to/from a base station, without limiting to the mobile phone.

In an exemplary method for controlling a function of a mobile phone in embodiments of the present invention, the mobile phone receives a control signal at the entrance of a specific area to restrict one or more functions, and releases the function restriction at the exit of the specific area. The method preferably does not transmit the control signal over a total area in which the mobile phone's function is restricted, but transmits the control signal only to the entrance of the specific area, thereby implementing a low power transmission.

Herein, the mobile phone's function to be restricted can be at least one of the entire plurality of mobile phone functions, such as camera functions, call functions, transmission/reception functions, functions for changing from ringer mode to vibrate mode, music play functions, power on/off functions, and so on, that can be controlled in a wired/wireless link by a user or supplier of the mobile phone.

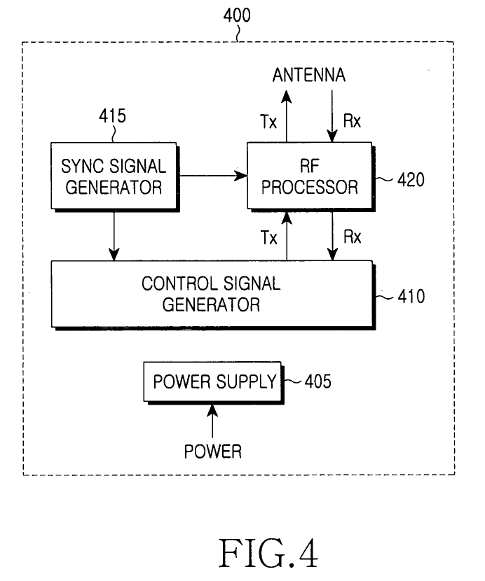

FIG. 3 illustrates a structure of a system for controlling a function of a mobile phone in accordance with an exemplary embodiment of the present invention.

To control the mobile phone's function in embodiments of the present invention, the system is installed in a specific area in which the mobile phone's function is restricted, i.e., a restricted area 340, an unrestricted area 300, and a boundary area 320. The system restricts the mobile phone's function at the entry, and releases the restriction of the mobile phone's function at the exit as described in greater detail below. The system comprises a manager 326 and two transmitters 322 and 324 for transmitting control signals to the mobile phone. Herein, the boundary area 320 may be the entrance/exit of a secured building, exhibit hall, performance hall, and so on, designated as the restricted area 340.

Referring to FIG. 3, the two transmitters 322 and 324 for transmitting the control signals to the mobile phone are preferably Security System Main Units (SSMUs), and the manager 326 is preferably an SSMU Manager (SM).

The SM 326 downloads various information (software management information) to SSMU#1 322 and SSMU#2 324 and collects and manages various fault and state information of SSMU#1 322 and SSMU#2 324. The SM 326 is preferably constructed with a Graphic User Interface (GUI) to provide convenience for an operator of the system for controlling the mobile phone's function.

Under control of the SM 326, the SSMU#1 322 and SSMU#2 324 transmit a signal for controlling the mobile phone's function, respectively, and control transmission power to extend or reduce an area where the control signals are transmitted. The signal for controlling the mobile phone's function is a pilot signal with a Pseudo Noise (PN) code used for identification of a base station and synchronization between the base station and a mobile station in the base station of a mobile communication system. For example, the pilot signal for identifying the base station has one of 512 PN offsets. In embodiments of the present invention, the mobile phone's function is controlled using the offsets.

When the SSMU#1 322 and SSMU#2 324 transmit pilot signals with PN offsets of different particular values, the mobile phone receives the pilot signals and determines the entrance to an area where the mobile phone's function is restricted.

The SSMU#1 322 and SSMU#2 324 have pilot signal transmission areas 310 and 330 that have a predetermined range, respectively. The SSMU#l 322 located in the boundary area 320 forms the first area 310 by transmitting a first pilot signal of a specific PN offset (e.g., “1”) in the direction of the unrestricted area 300. Similarly, the SSMU#2 324 located in the boundary area 320 forms the second area 330 by transmitting a second pilot signal of another PN offset (e.g., “511”) in the direction of the restricted area 340.

The mobile phone's function is controlled by searching pilot signals with special PN offsets (e.g., numbers of “1” and “511”) transmitted from the SSMU#1 322 and SSMU#2 324. For example, when a user of the mobile phone 302 moves to the first area 310 where the SSMU#1 322 transmits PN “1” corresponding to a signal for controlling the mobile phone's function in the unrestricted area 300, the mobile phone 302 detects PN “1”, determines that it is present in an area where control is required, makes a change from slot mode to non-slot mode, and searches for PN “511”. Herein, the mobile phone can more quickly search for PN “511” by monitoring all slots of one frame in the non-slot mode as compared with the slot mode in which the mobile phone monitors a received signal only in a particular slot.

If the user has passed through the first area 310 and has entered the second area 330 in which PN “511” is transmitted from the SSMU#2 324, the mobile phone 302 of the user successively detects PN “1” and PN “511”, determines that it has moved to the restricted area 340 where a restriction is required, restricts a particular function, and reduces power consumption by making a change to the slot mode. Herein, the particular function can be a function predefined in the mobile phone, for example, at least one of a power supply function, camera function, ringer function, and call function.

Then, in a state in which the mobile phone's function is restricted, the mobile phone searches for PN “511”. If the mobile phone 302 has found PN “511” while moving to the exit, for the boundary area 320, and out of the restricted area 340, it makes a change to the non-slot mode and attempts to search for PN “1”. If the mobile phone 302 has passed through the boundary area 320 and has found PN “1” in the unrestricted area 300, it releases a state in which the mobile phone's function is restricted and makes a change to the slot mode.

Meanwhile, FIG. 3 is an exemplary embodiment using two mobile phones' control signal transmitters 322 and 324. And, one mobile phone's control signal transmitter can separately transmit each of pilot signals with different PN offset to restricted area 340 and unrestricted area 300 by using two antennas.

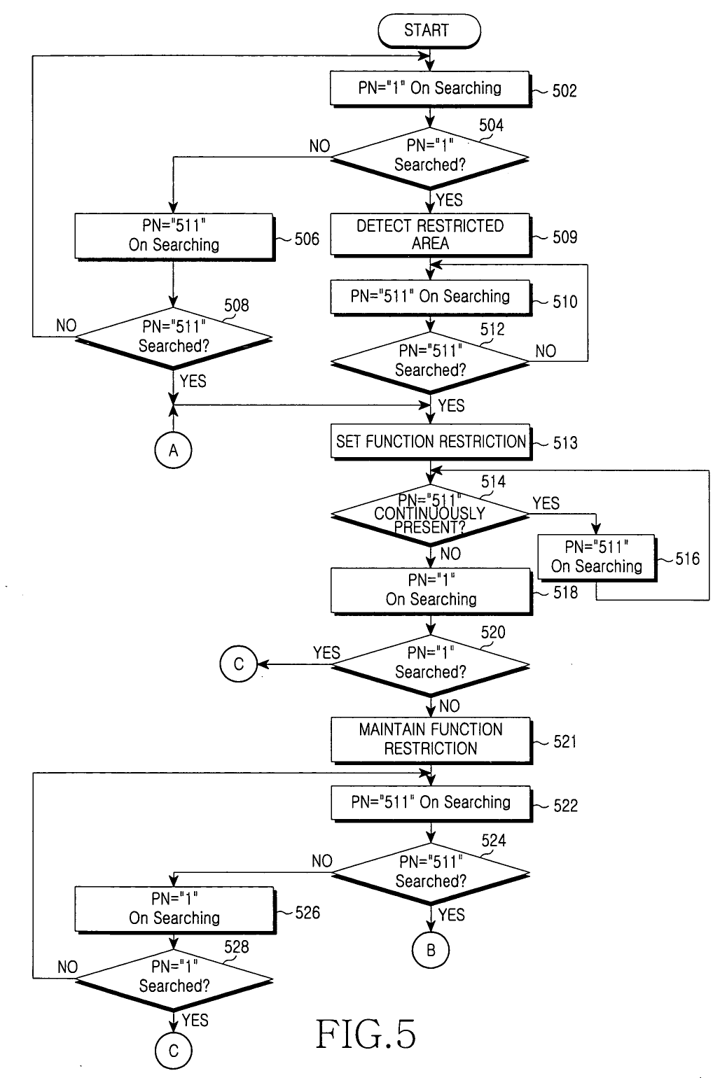

FIG. 4 is a block diagram of a transmitter 322 and 324 for transmitting a signal for controlling a mobile phone 302 in accordance with an exemplary embodiment of the present invention.

The transmitter 400 of FIG. 4 comprises a power supply 405 for supplying power, a control signal generator 410 for performing functions of digital signal processing and Code Division Multiple Access (CDMA) modulation to generate a control signal, a synchronization signal generator 415 for acquiring synchronization of a CDMA pilot signal, and a Radio Frequency (RF) processor 420 for converting a digital signal into an analog signal, up-converting the analog signal into an RF signal, and amplifying the RF signal.

The transmitter 400 for transmitting the control signal to control the mobile phone 302 operates under the control of the manager 326. When the manager 326 selects a PN offset number to be transmitted, the control signal generator 410 generates a pilot signal corresponding to the PN offset number synchronized to a synchronization signal generated from the synchronization signal generator 415. The pilot signal generated from the control signal generator 410 is an Intermediate Frequency (IF) signal and is transmitted to the RF processor 420. The RF processor 420 converts the pilot signal received from the control signal generator 410 into an analog signal, and up-converts the analog signal into a cellular frequency and/or a Personal Communication Service (PCS) frequency band. The signal converted into the RF is transmitted to an antenna through an RF amplifier and is propagated in the air.

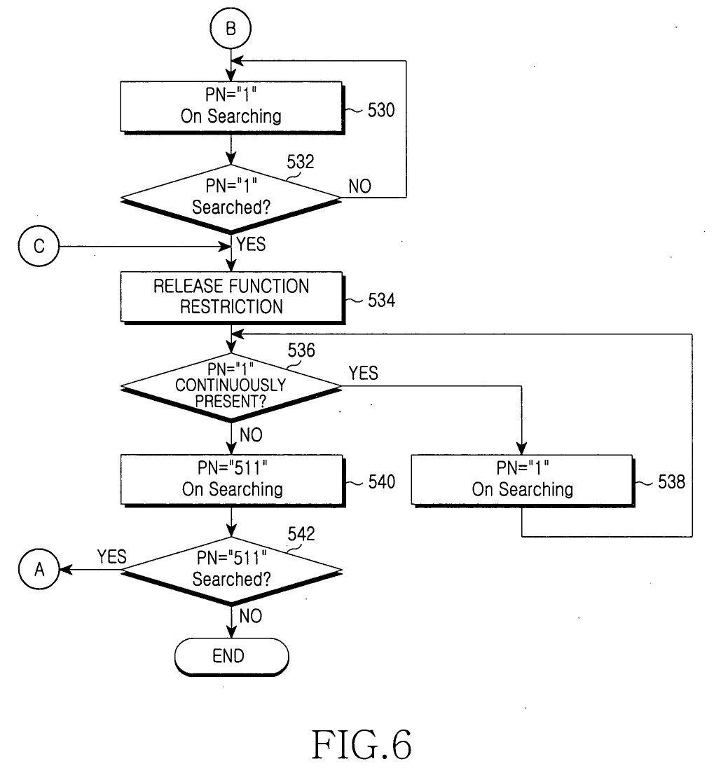

FIGS. 5 and 6 are flowcharts illustrating an operation for controlling a function of a mobile phone in accordance with an exemplary embodiment of the present invention.

In step 502, the mobile phone searches for PN “1”. When receiving PN “1” transmitted from a transmitter for transmitting a signal for controlling the mobile phone installed in a boundary area relative to an area where a function is restricted or a restricted area in step 504, the mobile phone detects a state in which the entrance to the restricted area is in progress in step 509, and proceeds to step 510 to search for PN “511”. However, if PN “1” has not been received in step 504, the mobile phone proceeds to step 506 to search for PN “511”. Thereafter, the mobile phone is determined to be present in the restricted area if PN “511” has been found in step 508. A function restriction is then set in step 513. However, if PN “511” has not been found, the mobile phone returns to step 502.

If the mobile phone has found PN “511” in step 512 after attempting to search for PN “511” in step 510, the function restriction is set in step 513. A determination is made as to whether PN “511” is continuously present in step 514. If PN “511” is continuously present in step 514, it is continuously searched for in step 516.

However, if PN “511” is not continuously present in step 514, PN “1” is searched for in step 518. When the special PN “1” has been found in step 520, a restriction of the mobile phone's function is released in step 534 of FIG. 6. If the special PN “1” has not been found, the mobile phone determines that it is still present in the restricted area and maintains the function restriction in step 521.

In step 522, the mobile phone searches for PN “511”. Step 522 corresponds to the case where the mobile phone again moves from the unrestricted area to the restricted area. If PN “511” has been found in step 524, the mobile phone proceeds to step 530 corresponding to the case where it moves from the restricted area to the unrestricted area. If PN “511” has not been found in step 524, the mobile phone proceeds to step 526 to search for PN “1”.

If PN “1” has been found in step 528, the mobile phone proceeds to step 534. If PN “1” has not been found within a predetermined time, the mobile phone returns to step 522 to again search for PN “511”.

In step 530, PN “1” is searched for. If the special PN “1” has been found in step 532, the function restriction is released in step 534. If PN “1” is continuously present in step 536, it is continuously searched for in step 538. A determination is made as to whether PN “1” is continuously present. If PN “1” is not continuously present at step 536, the mobile phone proceeds to step 540 to search for PN “511”. If PN “511” has been found in step 542, the mobile phone returns to step 513 to set the function restriction. However, if PN “511” has not been found in step 542, the operation ends or returns to step 502 because the mobile phone is not located in the unrestricted area.

Various cases can be applied in which an operation for controlling the mobile phone is possible over various movement paths, such that the mobile phone does not operate abnormally.

In this case, excessive or uncontrollable operation in an overlapping area can be prevented using a strength threshold of a received signal. For example, when Ec/Io of a pilot signal is more than −12 dB, a terminal determines that the pilot signal is present. When Ec/Io of a pilot signal is less than −20 dB, the terminal determines that the pilot signal is absent. The threshold of signal strength is used to prevent the excessive or uncontrollable operation of the terminal in the overlapping area.

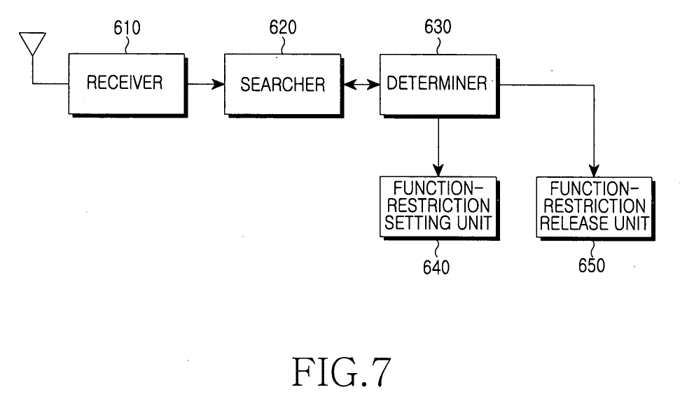

FIG. 7 is a block diagram of a structure for controlling a function of the mobile phone in accordance with an exemplary embodiment of the present invention.

A receiver 610 receives a function control signal including a special PN offset. A searcher 620 searchs whether a pilot signal of a specific PN Offset (or PN) value (e.g., “1” or “511”) has been received in the receiver 610. Determination information is provided to a determiner 630. If the mobile phone receives PN “511” after receiving PN “1” as it moves from the unrestricted area to the restricted area, the determiner 630 sets a function restriction according to the PN offset through a function-restriction setting unit 640.

Then, if the mobile phone receives PN “1” after receiving PN “511” as it moves from the restricted area to the unrestricted area, the determiner 630 releases the function restriction set by the function-restriction setting unit 640 through a function-restriction release unit 650. The function-restriction setting unit 640 and the function-restriction release unit 650 can be integrated into one function-restriction controller.

When the mobile phone moves to the unrestricted area without entering the restricted area from an area where PN “511” is transmitted, the determiner 630 commands the searcher 620 to search for PN “1” and transfers a function restriction release command to the function-restriction release unit 650 when PN “1” is received. When the mobile phone again moves to the restricted area after moving from the restricted area to the unrestricted area, the determiner 630 commands the searcher 620 to search for PN “511” and transfers a function restriction command to the function-restriction setting unit 640 when PN “511” is received.

Exemplary embodiments of the present invention in which the above-described operation is performed has the following effects.

The embodiments of present invention can restrict a function of a mobile phone in a specific area or place where privacy infringement, information leakage, and so on, may occur. Moreover, embodiments of the present invention can design a transmitter for transmitting a control signal at low power in a scheme for installing the transmitter in a specific area and performing control. Moreover, embodiments of the present invention can be cost-effective because an additional device is unnecessary within the mobile phone and can be universally applied through software standardization.

Although the exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. A method for controlling a function of a user terminal in a mobile communication system, comprising the steps of:
receiving a pilot signal with a Pseudo Noise (PN) code;
determining whether the received pilot signal has a predefined PN offset;
setting a restriction of a particular function of the user terminal when the pilot signal is a predefined first PN offset; and
releasing the restriction of the particular function of the user terminal when the pilot signal is a predefined second PN offset.

2. The method of claim 1, further comprising the steps of:
restricting the particular function of the user terminal by executing a function restriction command mapped to the first PN offset when the pilot signal is the first PN offset; and
releasing the restriction of the particular function of the user terminal by executing a function restriction release command mapped to the second PN offset when the pilot signal is the second PN offset.

3. An operation method in a transmitter for transmitting a signal for controlling a user terminal in a mobile communication system, the transmitter having transmission areas serving as a first area where a restriction of a particular function of the user terminal is set and a second area where the set function restriction is released, respectively, comprising the steps of:
generating pilot signals having a Pseudo Noise (PN) offset defined to set the restriction of the particular function of the user terminal and a PN offset defined to release the set restriction of the particular function, respectively; and
transmitting the generated pilot signals to the first and second areas.

4. A method for controlling a function of a user terminal in a mobile communication system, comprising the steps of:
having transmission areas serving as a first area where a restriction of a particular function of the user terminal is set and a second area where the set function restriction is released and transmitting a first pilot signal defined to restrict the particular function of the user terminal and a second pilot signal defined to release the restriction of the particular function to the first and second areas;
setting the restriction of the particular function when the user terminal receives the first pilot signal; and
releasing the restriction of the particular function set in the user terminal when the second pilot signal is received.

5. The method of claim 4, wherein the pilot signals have a predefined Pseudo Noise (PN) offset.

6. An apparatus for controlling a function of a user terminal in a mobile communication system, comprising:
a receiver for receiving a pilot signal with a Pseudo Noise (PN) code;
a determiner for determining whether the received pilot signal has a predefined PN offset; and
a controller for setting a restriction of a particular function of the user terminal when the pilot signal is a predefined first PN offset and releasing the restriction of the particular function set in the user terminal when the pilot signal is a predefined second PN offset.

7. The apparatus of claim 6, further comprising:
a searcher for searching whether the pilot signal received by the receiver has the predefined PN offset.

8. The apparatus of claim 6, wherein the controller restricts the particular function of the user terminal by executing a function restriction command mapped to the first PN offset when the pilot signal is the first PN offset and releases the restriction of the particular function of the user terminal by executing a function restriction release command mapped to the second PN offset when the pilot signal is the second PN offset.

9. An apparatus for transmitting a signal for controlling a user terminal in a mobile communication system having transmission areas serving as a first area where a restriction of a particular function of the user terminal is set and a second area where the set function restriction is released, respectively, comprising:
a control signal generator for generating pilot signals having a Pseudo Noise (PN) offset defined to set the restriction of the particular function of the user terminal and a PN offset defined to release the set restriction of the particular function, respectively; and
a transmitter for transmitting the generated pilot signals to the first and second areas.

10. A mobile communication system for controlling a function of a user terminal, comprising:
a control signal transmitter for having transmission areas serving as a first area where a restriction of a particular function of the user terminal is set and a second area where the set function restriction is released and transmitting a first pilot signal defined to restrict the particular function of the user terminal and a second pilot signal defined to release the restriction of the particular function to the first and second areas; and
the user terminal for setting the restriction of the particular function when receiving first pilot signal and releasing the set restriction of the particular function when receiving the second pilot signal.

11. The mobile communication system of claim 10, wherein the pilot signals have a predefined Pseudo Noise (PN) offset.
